(19) United States
(12) Patent Application Publication
(10) Pub. No.: US 2013/0228247 A1
(43) Pub. Date: Sep. 5, 2013

(54) Canted, single vane, three-way butterfly valve

(71) Applicant: Hans D. Baumann, W. Palm Beach, FL (US)

(72) Inventor: Hans D. Baumann, W. Palm Beach, FL (US)

(21) Appl. No.: 13/385,686

(22) Filed: Mar. 2, 2012

(51) Int. Cl. F16K 1/22

(52) U.S. Cl. 137/887

(57) ABSTRACT

A canted, single vane three-way butterfly valve having a T-shaped housing having an inlet and one outlet port, a third port straddling said inlet and outlet ports, a single vane interspaced between the inlet and outlet ports supported by a central shaft, capable to selectively blocking fluid flow emanating from either inlet or outlet ports from entering said third port when the plenary axis of said vane is tilted forty five degrees from the central axis of either inlet or outlet ports.

### INTRODUCTION AND BACKGROUND OF THE INVENTION

This valve design represents a low cost solution for applications in present process control. It requires no bonnet openings and other leak-prone valve openings other than for a rotating shaft passage.

Similar butterfly valves, such as represented by U.S. Pat. No. 6,216,737 B1, require two separate vanes of conventional shape, connected by an external linkage drive. These valves are cumbersome and expensive. Each vane has a diverse flow characteristic due to their diverse locations on a pipe tee.

My invention does not require such complex shapes and can make-do with one single vane able to control flow through two separate ports at the same time. Other three-way designs are in the shape of a plug valve as exemplified by U.S. Pat. No. 3,721,265. This valve experiences rubbing friction when the plug is rotated., Such friction is absent in my invention. Furthermore, the flow passages are very restricted limiting flow.

Yet, another prior art device is shown in U.S. Pat. No. 3,592,221. While this device constitutes a rotary three-way valve, it can only switch from one port to the other and is not able to modulate the rate of two flows simultaneously, as is the purpose and function of my device.

In addition, there is a three-way butterfly valve shown in U.S. Pat. No. 4,273,157. Here is a vane, while seating at an angle, is not able to rotate 90 degrees and shut off two separate, but identical, ports. Port 26 is a small by-pass opening and is only closed, when vane 17 has nearly fully opened seat 27. It does not teach the modulation and control of fluid from and to identical ports.

Finally, there is U.S. Pat. No. 5,193,572, showing a single, rotatable vane in a three- way housing configuration. Here, the single vane 30 is meant to evacuate fluid from a horizontal pipe 50. No three-way control functions are implied..

My invention overcomes all these disadvantages by providing a simple, low weight, and low cost solution to three-way modulating process applications. Here, a single vane is able to either modulate between, or, shut off two identical ports, rotating the vane from one closed position at 45 degrees from the vertical to another 45 degrees position after traveling 90 degrees. It can do this by having two 90 degree opposed seating surfaces.

Furthermore, my vane is concave to gently bend fluid into, or out of, the third, vertical, port. This significantly increases the flow capacity of my valve. The outside of the vane is convex and it hugs the interior bore of the housing. Thereby preventing un-authorized fluid to by-pass the uncontrolled upper portion of the vane.

Finally, there is no contact between vane and housing, other than in the closed position. This means absence of rotating friction (other than in the shaft bearings), a great feature, when used for automatic control purposes.

These, and other advantages of my invention will become more clear, when viewing the accompanying drawing and the following description.

### BRIEF DESCRIPTION OF THE DRAWINGS

FIG. 1 is a longitudinal, sectional view of a preferred embodiment of my invention in a configuration, where opening B is connected to opening C.

FIG. 2 is a cross-sectional view of the invention taken at the vertical, central axis of FIG. 1.

FIG. 3 is a longitudinal, sectional view of the invention, wherein the longitudinal bore is lined with a rubber-like substance, and wherein the vane is in the partly open position.

FIG. 4 is an enlarged view of the vane in my invention, having a flattened shape.

### DETAILED DESCRIPTION

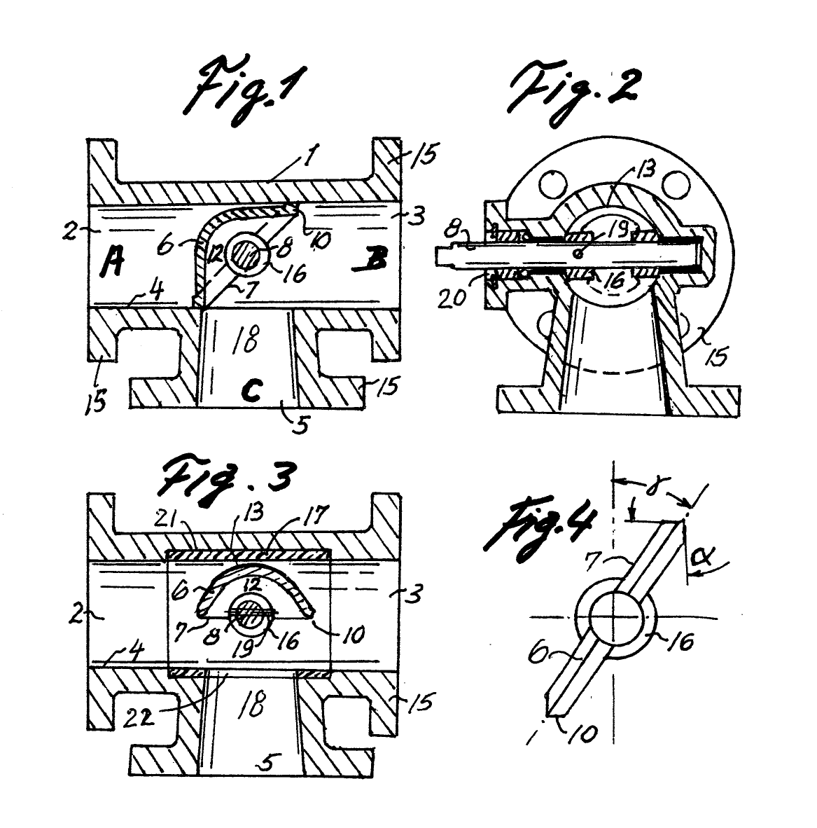

FIG. 1 showing a preferred embodiment of my invention, shows a housing 1 having three flanged openings, labeled A, B, and C with fluid access ports 2, 3, and 5 receptively. Ports 2 and 3 are connected by a straight, circular bore 4, while port 5 has a vertical bore 18, connected with bore 4.

A shaft 8 located perpendicular to and at the intersection of bores 4 and 18. A rotatable vane 6 is mounted on said shaft and having a plenary oval surface 7 3 having a circular periphery 10, being slanted 45 degrees on either side of the oval surface (α=90 degrees). The slanted surfaces are capable of interfacing closely with the interior surfaces of bore 4 at an angle γ of about 45 degrees.

The plenary surface 7 has a bulging indentation 12, whose outer radius closely matches the radius of bore 4. Ring-shaped supports 16 help to secure the shaft against the vane with the assistance of a pin 19. Shaft 8 furthermore penetrates housing 1 through a suitable opening 20.

While FIG. 1 shows the vane 6 in a position, where opening B is fully connected to opening C, a right-hand turn of shaft 8 will rotate said vane 90 degrees and close opening B while fully connecting A to opening C.

FIG. 3 shows the vane 6 in a 45 degree position, thereby providing equal access from openings A and B to opening C. Here the housing bore 4 is lined with an elastomeric substance 17, to help slanted surfaces 10 to provide better shut-off by being able to compress the liner 17. An opening 22 in liner 17 allows fluid access from port 5.

FIG. 4 shows an alternate configuration of the vane 6 in an enlarged view for clarity. Here the plenary, oval surface of the vane is flat and without the bulging indentatiom 12. This configuration, while easier to machine, has undesirable fluid impediments due to the absence of the streamlining flow passage provided by the bulging recess.

The unique feature of the invention is, that contrary to state of the art devices, the same configuration can be utilized for either diverting or mixing service. While in the diverting mode, flow entering opening C can be diverted either to opening A, or opening B. In a mixing mode, different fluids entering openings A and B can be mixed at any desired ratio before leaving opening C.

While the invention has been shown in a preferred configuration, numerous modification may be made without departing from the scope of the following claims. For example, housing 1 may connect to piping using threaded ends rather than flanges. Furthermore, my vane can be designed for an operating travel of 60 degrees, instead of the preferred 90 degrees. In that case, angle y becomes 60 degrees instead of 45 degrees and angle a becomes 60 degrees, instead of 90 degrees.

1. A canted, single vane, three-way butterfly valve, comprising a housing 1 having an inlet port 2, an outlet port 3, a straight bore 4 connecting both inlet and outlet ports, a third port 5 located perpendicular to said straight bore, a tillable vane 6 having an oval plenary surface 7, a shaft 8 passing near the center of said plenary surface and being supported by suitable openings within said housing, said shaft being capable of rotating said vane about ninety degrees to either side preventing fluid from passing from the inlet port to the third port, or, from the outlet port to said third port.

2. A canted, single vane, three-way butterfly valve as in claim 1, wherein the outer circumference of the oval shaped vane comprises a seating rim 10 having a triangular cross-section to closely contacting the inner circumference of the straight bore.

3. A canted, single vane, three-way butterfly valve as in claim 1, wherein said vane has a central, cup-shaped indentation 12 configured to help guide fluid from the central bore into the third port.

4. A canted, single vane, three-way butterfly valve as in claim 3, wherein said cup-shaped indentation has an outer wall surface 13 whose geometry closely matches the radius of the inner housing bore.

5. A canted, single vane, three-way butterfly valve as in claim 1, wherein the three ports of said housing have flanges 15 suitable to be connected to fluid conducting pipe lines.

6. A canted, single vane, three-way butterfly valve as in claim 2, wherein the seating rim of said vane is closingly contacting the inner surface of said straight bore at an angle of approximately 45 degrees from the axis of said oval plenary surface 7.

7. A canted, single vane, three-way butterfly valve as in claim 1, wherein one portion of said shaft extends to the outside of said housing to connect to suitable operating means.

8. A canted, single vane, three-way butterfly valve as in claim 1, wherein said vane has opposing ring-shaped attachments 16 helping to support said shaft.

9. A canted, single vane, three-way butterfly valve as in claim 1, wherein said oval plenary surface is flat.

10. A canted, single vane, three-way butterfly valve as in claim 1, wherein said straight housing bore 4 has an enlarged diameter section 21 suitably dimensioned to receive an elastomeric insert 17 whose inside diameter is slightly smaller than the outer circumference of said oval shaped vane thereby preventing fluid from leaking past the vane when the latter is in a closed port position.

11. A canted, single vane, three-way butterfly valve as in claim 10, wherein said elastomeric insert is permanently fastened to the enlarged diameter portion 21 of said straight bore.

12. A canted, single vane, three-way butterfly valve as in claim 10, wherein said elastomeric insert has an opening 22 capable to permit fluid to enter said third port 5.
